(19) United States
(12) Patent Application Publication
(10) Pub. No.: US 2024/0141933 A1
(43) Pub. Date: May 2, 2024

(54) FASTENING ELEMENT

(71) Applicant: DTECH PRECISION INDUSTRIES CO., LTD., New Taipei City (TW)

(72) Inventor: TING-JUI WANG, New Taipei City (TW)

(21) Appl. No.: 18/457,372

(22) Filed: Aug. 29, 2023

(30) Foreign Application Priority Data
Oct. 27, 2022 (TW) 111140837

(51) Int. Cl. F16B 5/02

(52) U.S. Cl. CPC F16B 5/02

(57) ABSTRACT

A fastening element includes a body portion and a fastening portion. The body portion is used to assemble a first object. The fastening portion is movably combined in the body portion, the fastening portion is provided with a height limiting portion, and the fastening portion is used to assemble a second object. The height limiting portion is abutted against the second object or limits a fastening stroke of the fastening portion, or the height limiting portion limits a distance between the first object and the second object. Accordingly, the fastening element can quickly combine and separate at least two objects, and achieve the effect of combining and separating repeatedly and quickly.

### CROSS-REFERENCE TO RELATED APPLICATION

This non-provisional application claims priority under 35 U.S.C. § 119(a) on Patent Application No(s). 111140837 filed in Taiwan, R.O.C. on Oct. 27, 2022, the entire contents of which are hereby incorporated by reference.

### BACKGROUND OF THE INVENTION

### 1. Field of the Invention

The present disclosure relates to a fastening element, and in particular to a fastening element that can be used to combine and separate at least two objects repeatedly and quickly.

### 2. Description of the Related Art

When combining at least two objects, it is usually achieved by attaching with screws to combine the objects.

In terms of the above-mentioned customary fixing method, although at least two objects can be fixed and combined in a manner that is not easy to separate. In addition to causing a situation that is not easy to assemble the objects, at least one object will be difficult to disassemble because of the conventional fixing and combining method using screws.

### BRIEF SUMMARY OF THE INVENTION

To overcome the disadvantages of the prior art, the present invention provides a fastening element, with a view to achieving the effect of combining and separating objects repeatedly and quickly.

To achieve the above objectives and more, the present disclosure provides a fastening element, including a body portion and a fastening portion. The body portion is used to assemble a first object. The fastening portion is movably combined in the body portion, the fastening portion is provided with a fastening portion limiting member, the fastening portion limiting member is a height limiting portion, the fastening portion is used to assemble a second object, the height limiting portion is abutted against the second object or limits a fastening stroke of the fastening portion, or the height limiting portion limits a distance between the first object and the second object.

The present disclosure further provides a fastening element, including a body portion and a fastening portion. The body portion is used to assemble a first object. The fastening portion is movably combined in the body portion, and the fastening portion is assembled with a fastening portion limiting member.

The present disclosure further provides a fastening element, including a body portion and a fastening portion. The body portion is used to assemble a first object. The fastening portion is movably combined in the body portion, the fastening portion is assembled with a fastening portion limiting member, wherein the fastening portion and the body portion therebetween have a first floating amount, or the fastening portion limiting member and the body portion therebetween have a second floating amount.

In the above fastening element, the fastening element further includes an elastic element, two ends of which are respectively abutted against the body portion and the fastening portion, or the body portion cooperates with the elastic element to abut and press on the first object, in order to limit the distance between the first object and the second object.

In the above fastening element, the fastening portion is provided with a limiting portion, the limiting portion is abutted against the body portion to limit the distance between the first object and the second object.

In the above fastening element, the height limiting portion is provided with a height limiting space, the height limiting space is used to cover a fastened portion of the second object.

In the above fastening element, the fastening portion limiting member is provided with a combination portion, the fastening portion is combined to the combination portion, or the combination portion or the fastening portion is provided with a stopping portion, the stopping portion is used to stop or limit the fastening portion limiting member.

In the above fastening element, the combination portion is combined with the fastening portion limiting member by a riveting combination, a fastening combination, a screwing combination, or another element passing combination.

In the above fastening element, the fastening portion is a threaded body, a cylinder body, an outer fastening body, or an inner fastening body.

In the above fastening element, the body portion is assembled to the first object by riveting, expanding, welding, fastening, or locking.

In the above fastening element, the first object and the second object therebetween have a limiting member, the limiting member limits the distance between the first object and the second object.

In the above fastening element, the fastening portion is fastened into a fastened portion of another object by cooperating with the first floating amount or the second floating amount, wherein the second floating amount is greater than, less than, or equal to the first floating amount.

In the above fastening element, the fastening portion is movably combined in the body portion, the fastening portion is assembled with a fastening portion limiting member, wherein the fastening portion and the body portion therebetween have a first floating amount, or the fastening portion limiting member and the body portion therebetween have a second floating amount, wherein a height limiting portion of the fastening portion limiting member is fastened into a fastened portion of another object by cooperating with the first floating amount or the second floating amount, wherein the second floating amount is greater than, less than, or equal to the first floating amount.

In the above fastening element, the height limiting portion is provided with a height limiting space, the height limiting space is used to cover a fastened portion of the second object, wherein the height limiting portion and the fastened portion therebetween have a floating amount.

In the above fastening element, the height limiting portion is provided with a height limiting space, the height limiting space is used to cover a fastened portion of the second object, wherein the height limiting portion and the fastened portion therebetween have a floating amount, the floating amount is less than, greater than, or equal to a first floating amount or a second floating amount.

Accordingly, the fastening element can quickly combine and separate at least two objects, and achieve the purpose of combining and separating repeatedly and quickly.

### BRIEF DESCRIPTION OF THE DRAWINGS

FIG. 1 is a schematic diagram of in use state of a fastening element according to an embodiment of the present disclosure.

FIG. 2 is a schematic diagram of different types of a fastening element according to an embodiment of the present disclosure.

FIG. 3 is a schematic diagram of an in use state of a fastening element according to an embodiment of the present disclosure.

FIG. 4 is a schematic diagram of an in use state of a fastening element according to an embodiment of the present disclosure.

FIG. 5 is a schematic diagram of an in use state of a fastening element according to an embodiment of the present disclosure.

### DETAILED DESCRIPTION OF THE INVENTION

To facilitate understanding of the objectives, characteristics, and effects of the present disclosure, embodiments together with the attached drawings for the detailed description of the present disclosure are provided as below.

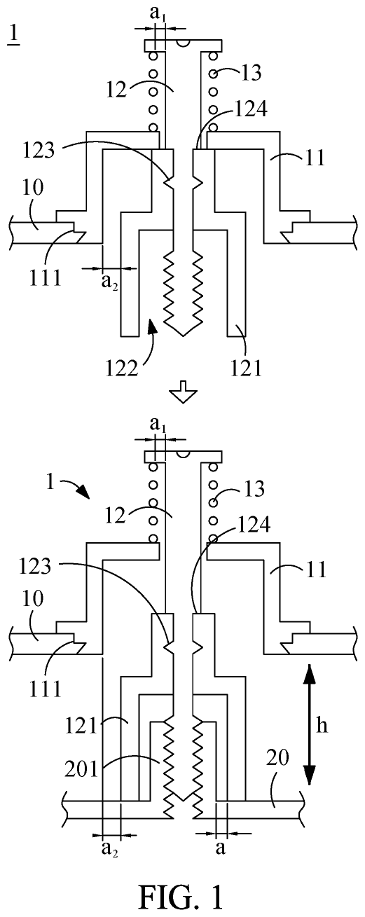

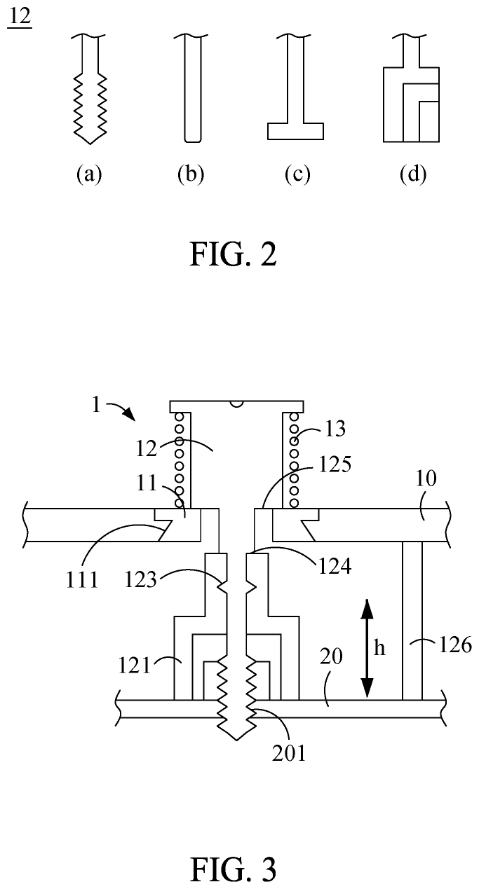

Referring to FIGS. 1 and 2, as shown in the drawings, the present disclosure provides a fastening element 1, which includes a body portion 11 and a fastening portion 12.

The body portion 11 is used to assemble to a first object 10.

The fastening portion 12 is movably combined in the body portion 11, the fastening portion 12 is provided with a height limiting portion 121, and the fastening portion 12 is used to assemble to second object 20. The height limiting portion 121 is abutted against the second object 20 and limits a fastening stroke of the fastening portion 12, and the height limiting portion 121 limits a distance h between the first object 10 and the second object 20.

When used, the fastening element 1 may be combined with the first object 10 by a junction segment 111 of the body portion 11 thereof, and the height limiting portion 121 is abutted against the second object 20. The fastening stroke of the fastening portion 12 is limited, and then the fastening portion 12 is assembled to the second object 20, and by the height limiting portion 121 limiting the distance h between the first object 10 and the second object 20. The body portion 11 and the fastening portion 12 are used to complete a quick combination of the first object 10 and the second object 20, and the first object 10 and the second object 20 therebetween have an appropriate distance h for subsequent assembly or related use.

When the first object 10 and the second object 20 are to be separated, the fastening portion 12 is unfastened (or unlocked) from the second object 20, and a quick separation of the two objects can be completed. By the aforementioned combination and separation type, the fastening element 1 can achieve the effect of combining and separating objects repeatedly and quickly.

In addition to the above, in an embodiment of the present disclosure, the fastening element further includes an elastic element 13, two ends of which are respectively abutted against the body portion 11 and the fastening portion 12. Thus, the body portion 11 may be used to cooperate with the elastic element 13 to abut and press on the first object 10, in order to limit the distance between the first object 10 and the second object 20, and the elastic element 13 is elastically abutted to cooperate with the height limiting portion 121 to limit the fastening stroke of the fastening portion 12. In addition, the elastic element 13 can be used to increase an operating feel of the fastening portion 12, and provide the effect of resetting the fastening portion 12 after unfastening (or unlocking) at the same time.

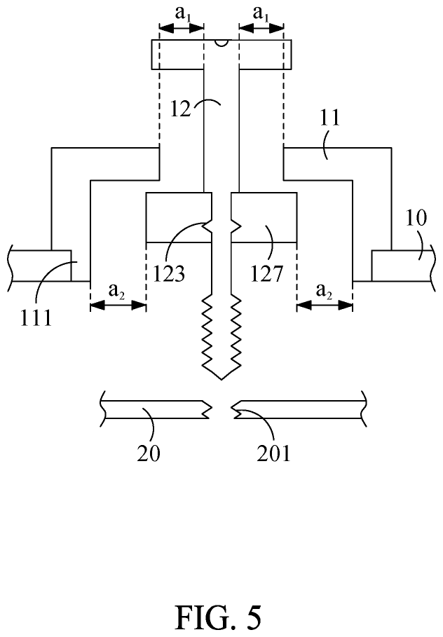

In addition to the above embodiments, in an embodiment of the present disclosure, the height limiting portion 121 is provided with a height limiting space 122. The height limiting space 122 is used to cover a fastened portion 201 of the second object 20, so that the fastened portion 201 enters or is stored in the height limiting space 122 of the height limiting portion 121. The height limiting portion 121 and the fastened portion 201 therebetween has a floating amount a, the floating amount a is less than, greater than, or equal to a first floating amount a1 or a second floating amount a2 (the positions of the first floating amount a1 and the second floating amount a2 are detailed in FIG. 5). Thus, when the fastening portion 12 is assembled to the second object 20, the height limiting space 122 of the height limiting portion 121 may first be provided at the fastened portion 201 of the second object 20, so as to use the height limiting portion 121 to limit the distance h between the first object 10 and the second object 20, and adjust the position with the floating amount a, the first floating amount a1, and the second floating amount a2, and then assemble the fastening portion 12 to the fastened portion 201 of the second object 20. Thus, the body portion 11 and the fastening portion 12 complete the quick combination of the first object 10 and the second object 20, and the first object 10 and the second object 20 therebetween have an appropriate distance h, so as to facilitate subsequent assembly or related use.

In addition to the above embodiments, in an embodiment of the present disclosure, the fastening portion 12 is provided with a combination portion 123. The height limiting portion 121 is combined in the combination portion 123, and the combination portion is provided with a stopping portion 124, and the stopping portion 124 is used to stop or limit the height limiting portion 121. Thus, by the combination portion 123 cooperating with the stopping portion 124, the fastening portion 12 and the height limiting portion 121 may be firmly combined.

In addition to the above embodiments, in an embodiment of the present disclosure, the combination portion 123 is combined with the height limiting portion 121 by a riveting combination, a fastening combination, a screwing combination, or another element passing combination. Thus, different combinations may be selected, by cooperating with the stopping portion 124, the fastening portion 12 uses the combination portion 123 to firmly combine with the height limiting portion 121, so that the present disclosure can further meet the needs of practical applications.

In addition to the above embodiments, in an embodiment of the present disclosure, the fastening portion 12 is a threaded body (such as part a of FIG. 2), a cylinder body (such as part b of FIG. 2), an outer fastening body (such as part c of FIG. 2), or an inner fastening body (such as part d of FIG. 2). Thus, it can meet the needs of practical applications in response to different fastening (or locking) needs.

In addition to the above embodiments, in an embodiment of the present disclosure, the junction segment 111 of the body portion 11 is assembled to the first object 10 by riveting, expanding, welding, fastening, or locking. The fastening element 1 is firmly combined with the first object 10 to facilitate the performance of the fastening portion 12 in subsequent operations.

In addition to the above embodiments, in an embodiment of the present disclosure, the height limiting portion 121 and the fastened portion 201 therebetween have a floating amount a, and the floating amount a is less than, greater than, or equal to a first floating amount a1 or a second floating amount a2.

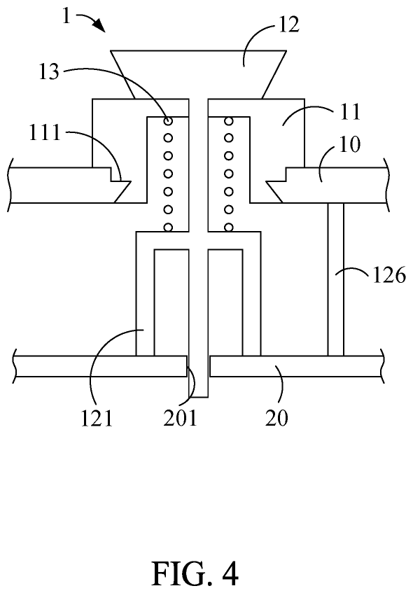

Referring to FIGS. 3 and 4, as shown in the drawings, in addition to the above embodiments, in an embodiment of the present disclosure, the fastening portion 12 is provided with a limiting portion 125. The limiting portion 125 is abutted against the body portion 11 to limit the distance h between the first object 10 and the second object 20. Thus, after the fastening portion 12 is assembled to the second object 20, and the height limiting portion 121 or the limiting portion 125 is used to limit the distance h between the first object 10 and the second object 20. The first object 10 and the second object 20 have an appropriate distance h, so as to facilitate subsequent assembly or related use.

In addition to the above embodiments, in an embodiment of the present disclosure, the first object 10 and the second object 20 therebetween have a limiting member 126, and the limiting member limits the distance h between the first object and the second object. Thus, after the fastening portion 12 is assembled to the second object 20, and the height limiting portion 121, the limiting portion 125, or the limiting member 126 is used to limit the distance h between the first object 10 and the second object 20. The first object 10 and the second object 20 have an appropriate distance h, so as to facilitate subsequent assembly or related use.

Referring to FIG. 5, as shown in the drawing, in addition to the above embodiments, the present disclosure further provides a fastening element 1, which includes a body portion 11 and a fastening portion 12.

The body portion 11 is used to assemble an object.

The fastening portion 12 is movably combined in the body portion 11, the fastening portion 12 may be assembled to a fastening portion limiting member 127 in the combination portion 123 (and the fastening portion limiting member 127 may be the aforementioned height limiting portion 121). The fastening portion 12 and the body portion 11 therebetween have a first floating amount a1, the fastening portion limiting member 127 and the body portion 11 have a second floating amount a2, and the second floating amount a2 is greater than, less than, or equal to the first floating amount a1. Thus, the fastening position may be fine-tuned by the first floating amount a1 and the second floating amount a2, so that the fastening portion 12 is easily fastened into the fastened portion 201 of the second object 20 by the first floating amount a1 cooperating with the second floating amount a2, and thus the present disclosure can further meet the needs of practical application.

While the present invention has been described by means of specific embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. A fastening element, comprising:
a body portion, used to assemble a first object; and
a fastening portion, movably combined in the body portion, the fastening portion is provided with a fastening portion limiting member.

2. The fastening element according to claim 1, wherein the fastening portion limiting member is a height limiting portion, the fastening portion is used to assemble a second object, and the height limiting portion is abutted against the second object or limits a fastening stroke of the fastening portion, or the height limiting portion limits a distance between the first object and the second object.

3. The fastening element according to claim 1, wherein the fastening portion and the body portion therebetween have a first floating amount, or the fastening portion limiting member and the body portion therebetween have a second floating amount.

4. The fastening element according to claim 1, further comprising an elastic element, two ends of which are respectively abutted against the body portion and the fastening portion, or the body portion cooperates with the elastic element to abut and press on the first object, in order to limit the distance between the first object and the second object.

5. The fastening element according to claim 1, wherein the fastening portion is provided with a limiting portion, the limiting portion is abutted against the body portion to limit the distance between the first object and the second object.

6. The fastening element according to claim 2, wherein the height limiting portion is provided with a height limiting space, the height limiting space is used to cover a fastened portion of the second object.

7. The fastening element according to claim 1, wherein the fastening portion limiting member is provided with a combination portion, the fastening portion is combined to the combination portion, or the combination portion or the fastening portion is provided with a stopping portion, the stopping portion is used to stop or limit the fastening portion limiting member.

8. The fastening element according to claim 7, wherein the combination portion is combined with the fastening portion limiting member by a riveting combination, a fastening combination, a screwing combination, or another element passing combination.

9. The fastening element according to claim 1, wherein the fastening portion is a threaded body, a cylinder body, an outer fastening body, or an inner fastening body.

10. The fastening element according to claim 1, wherein the body portion is assembled to the first object by riveting, expanding, welding, fastening, or locking.

11. The fastening element according to claim 1, wherein the first object and the second object therebetween have a limiting member, the limiting member limits the distance between the first object and the second object.

12. The fastening element according to claim 3, wherein the fastening portion is fastened into a fastened portion of another object by cooperating with the first floating amount or the second floating amount, wherein the second floating amount is greater than, less than, or equal to the first floating amount.

13. The fastening element according to claim 3, wherein the fastening portion is movably combined in the body portion, the fastening portion is assembled with a fastening portion limiting member, wherein the fastening portion and the body portion therebetween have a first floating amount, or the fastening portion limiting member and the body portion therebetween have a second floating amount, wherein a height limiting portion of the fastening portion limiting member is fastened into a fastened portion of another object by cooperating with the first floating amount or the second floating amount, wherein the second floating amount is greater than, less than, or equal to the first floating amount.

14. The fastening element according to claim 2, wherein the height limiting portion is provided with a height limiting space, the height limiting space is used to cover a fastened portion of the second object, wherein the height limiting portion and the fastened portion therebetween have a floating amount.

15. The fastening element according to claim 2, wherein the height limiting portion is provided with a height limiting space, the height limiting space is used to cover a fastened portion of the second object, wherein the height limiting portion and the fastened portion therebetween have a floating amount, the floating amount is less than, greater than, or equal to a first floating amount or a second floating amount.
